(19) United States
(12) Patent Application Publication
(10) Pub. No.: US 2026/0171902 A1
(43) Pub. Date: Jun. 18, 2026

(54) CONTROLLER AND CONTROL METHOD FOR CONVERTER INCLUDING MULTIPLE PFC CIRCUITS

(71) Applicant: HYUNDAI AUTOEVER CORP., Seoul (KR)

(72) Inventors: Woo Won Rhee, Seoul (KR); Kyo Min Kim, Seoul (KR)

(73) Assignee: HYUNDAI AUTOEVER CORP., Seoul (KR)

(21) Appl. No.: 19/425,226

(22) Filed: Dec. 18, 2025

(30) Foreign Application Priority Data
Dec. 18, 2024 (KR) 10-2024-0189817

(51) Int. Cl. H02M 1/42; H02M 7/23

(52) U.S. Cl. CPC H02M 1/4208; H02M 1/0009; H02M 7/23

(57) ABSTRACT

A converter controller includes a first core configured, in each control period, to calculate pulse width modulation (PWM) control values for first switches included in a first power factor correction (PFC) circuit and configure registers for PWM signal output to the first switches. The converter controller further includes a second core configured, in each control period, to calculate PWM control values for second switches included in a second PFC circuit and store the PWM control values for the second switches in one of a plurality of second data variables selected according to a sequence number. The first core is further configured to configure registers for PWM signal output to the second switches based on a value of the selected second data variable.

### CROSS REFERENCE TO RELATED APPLICATION

This application claims the benefit of and priority to Korea Patent Application No. 10-2024-0189817, filed on Dec. 18, 2024, the entire contents of which are hereby incorporated herein by reference.

### TECHNICAL FIELD

The present disclosure relates to a control technology for a converter including a PFC (power factor correction) circuit.

### BACKGROUND

The statements in this section merely provide background information related to the present disclosure and may not constitute prior art.

An electric vehicle may include an on-board charger (OBC). The OBC may be a device that converts alternating current (AC) electricity supplied from an external power source into direct current (DC) electricity, which is usable within the vehicle. This device can provide converted power with a voltage and current suitable for the electric vehicle's battery pack. Additionally, the OBC may perform a function for controlling current and voltage during a power conversion process, thereby preventing overcharging of and damage to the battery.

The on-board charger (OBC) may include a power factor correction (PFC) circuit. The PFC circuit may be designed to maintain a consistent power factor for the alternating current (AC) supplied from an external power source. This circuit may operate by aligning the input current and the input voltage in phase, thereby improving the efficiency of electricity flow and reducing power loss. Additionally, the PFC circuit may include a filtering function to reduce electromagnetic interference with a power grid. This circuit may also improve the input current waveform of the OBC and enable stable power supply during a battery charging process.

The power factor correction (PFC) circuit may have limitations in the capacity of power it can handle. One of the factors determining the maximum power the circuit can process is the capacity of the switches included in the PFC circuit. The switch capacity may be set according to the current and voltage limits, and if the switches operate beyond their design specifications, overheating or damage may occur. Additionally, the capacity of the input filter included in the PFC circuit may also affect the power capacity. The input filter is designed to reduce electromagnetic interference from power coming into the circuit, and if the filter capacity is limited, the filter performance may degrade under high-power conditions. The capacity of the power lines can also influence the power limit of the circuit, and if the power lines reach an overload state, stable power delivery may become difficult. These factors may vary depending on the design and configuration of the PFC circuit.

To increase the power capacity of the power factor correction (PFC) circuit, multiple PFC circuits may be arranged in parallel within the on-board charger (OBC). Each of the PFC circuits arranged in parallel may independently process power, thereby enabling the entire PFC system to support a higher power capacity than a single circuit. This configuration can reduce the power load borne by each PFC circuit, lowering the likelihood of overheating or overloading each individual circuit. Furthermore, in a parallel structure, even if a specific circuit fails, the remaining circuits may continue to operate, potentially maintaining system stability.

To operate multiple power factor correction (PFC) circuits in parallel, it may be necessary to synchronize the control periods, switching periods, or duty cycles of two PFC circuits. Synchronizing the control periods may mean adjusting the control signals of the PFC circuits to operate at the same time intervals. Synchronizing the switching periods may refer to setting the on and off periods of the power switches in each circuit to keep them equal. Synchronizing the duty cycles may mean controlling each PFC circuit to maintain the same duty cycle. Such synchronization may serve as a method to minimize current and voltage imbalance between the parallel-connected circuits. If synchronization is not achieved, a specific circuit may end up handling excessive power, potentially leading to overheating or performance degradation.

### SUMMARY

Against this background, in one aspect, the present disclosure is directed to providing a technology for synchronously controlling a plurality of power factor correction (PFC) circuits. In another aspect, the present disclosure is directed to providing a technology that ensures data coherence when a plurality of PFC circuits is controlled by different cores.

An embodiment of the present disclosure provides a converter controller including a first core. The first core is configured, in each control period, to calculate pulse width modulation (PWM) control values for first switches included in a first power factor correction (PFC) circuit and configure registers for PWM signal output to the first switches. The converter controller further includes a second core. The second core is configured, in each control period, to calculate PWM control values for second switches included in a second PFC circuit and store the PWM control values for the second switches in one of a plurality of second data variables selected according to a sequence number. The first core is further configured to configure registers for PWM signal output to the second switches based on a value of the selected second data variable.

The second core may store the PWM control values for the second switches in one of two second data variables. The two second data variables are alternately selected and used.

The second core may store, in an index variable, a sequence number selected for a current control period or a sequence number to be selected for the next control period, among the plurality of second data variables.

The first core may check the second data variable selected according to the sequence number by the index variable.

The plurality of second data variables may be configured as an array, and one of the second data variables in the array may be selected according to the sequence number.

The first core may store the PWM control values for the first switches in one of plurality of first data variables selected according to a sequence number.

The plurality of first data variables and the plurality of second data variables may be located in a buffer shared by the first core and the second core.

The first core may configure the registers for PWM signal output to the first switches based on the value of the selected first data variable and may configure the registers for PWM signal output to the second switches based on the value of the selected second data variable.

In a top-level Interrupt Service Routine (ISR), the first core may configure the registers for PWM signal output to the first switches and may configure the registers for PWM signal output to the second switches.

The top-level ISR may be invoked a certain amount of time before a start of a new control period and may be finished before the start of the new control period.

The PWM control values may include at least one of a value indicating a duty cycle of the PWM signal or a value indicating a period of the PWM signal.

The first core may generate a rising edge time value or falling edge time value of the PWM signal from the value of the selected second data variable and may store the rising edge time value or falling edge time value in the registers for PWM signal output to the second switches.

The converter controller may further comprise timer output modules (TOMs) configured to output a PWM signal to the first switches and the second switches. The first core configures shadow registers (SR) respectively corresponding to the TOMs.

Each TOM may include a first CM register used for setting a rising edge of the PWM signal and a second CM register used for setting a falling edge of the PWM signal. The values stored in the shadow registers are transmitted to the first CM register and the second CM register at a start of a control period.

The first core may perform, in each control period, a process of acquiring sensing values from an Analog-to-Digital Converter (ADC) for the first PFC circuit, a voltage control process, and a current control process and may calculate the PWM control values for the first switches. The second core may perform, in each control period, a process of acquiring sensing values from an ADC for the second PFC circuit, a voltage control process, and a current control process and may calculate the PWM control values for the second switches.

Another embodiment of the present disclosure provides a converter control method including calculating, by a first core, pulse width modulation (PWM) control values for first switches included in a first power factor correction (PFC) circuit. The method further includes calculating, by a second core, PWM control values for second switches included in a second PFC circuit. The method further includes storing, by the first core, the PWM control values for the first switches in one of a plurality of first data variables selected according to a sequence number. The method further includes storing, by the second core, the PWM control values for the second switches in one of a plurality of second data variables selected according to a sequence number. The method further includes configuring, by the first core, registers for PWM signal output to the first switches based on a value of the selected first data variable and registers for PWM signal output to the second switches based on the value of the selected second data variable.

Storing the PWM control values for the first switches includes storing, by the first core, the PWM control values for the first switches in one of two first data variables, and the two first data variables may be alternately selected and used. Storing the PWM control values for the second switches includes storing, by the second core, the PWM control values for the second switches in one of two second data variables, and the two second data variables are alternately selected and used.

The method further includes storing, by the first core and the second core, in an index variable, a sequence number selected for a current control period or a sequence number to be selected for the next control period.

Configuring registers for PWM signal output to the first switches and the second switches may be performed in a top-level Interrupt Service Routine (ISR) of the first core.

The top-level ISR may be invoked a certain amount of time before a start of a new control period and may be finished before the start of the new control period.

As described above, according to the present disclosure, it is possible to synchronously control a plurality of power factor correction (PFC) circuits. Furthermore, according to the present disclosure, data coherence can be ensured when a plurality of PFC circuits is controlled by different cores.

### BRIEF DESCRIPTION OF THE DRAWINGS

FIG. 1 is a schematic diagram of a converter according to an embodiment.

FIG. 2 is a schematic diagram of a power factor correction (PFC) power stage according to one embodiment.

FIG. 3 is a waveform diagram of a first pulse width modulation (PWM) a-phase signal and a second PWM a-phase signal according to one embodiment.

FIG. 4 is a schematic diagram illustrating elements that determine control values of each PWM signal in one embodiment.

FIG. 5 illustrates an example diagram showing a control process performed by a single core during one control period.

FIG. 6 is a schematic diagram illustrating a problem that may arise when a single core simultaneously controls two PFC circuits during one control period.

FIG. 7 is a schematic diagram illustrating how two cores in a converter controller according to one embodiment control respective PFC circuits.

FIG. 8 is a schematic diagram of a converter controller according to one embodiment.

FIG. 9 is a schematic diagram of a timer output module (TOM) channel according to an embodiment.

FIG. 10 is a schematic diagram illustrating a procedure for cores to perform processes and waveforms of primary signals according to one embodiment.

FIG. 11 is a flowchart illustrating a converter control method according to one embodiment.

FIG. 12 is a detailed flowchart of step S1104 in the flowchart in FIG. 11.

FIG. 13 is a detailed flowchart of step S1106 in the flowchart in FIG. 11.

FIG. 14 is a detailed flowchart of step S1108 in the flowchart in FIG. 11.

The drawings described herein are for illustration purposes only and are not intended to limit the scope of the present disclosure in any way.

### DETAILED DESCRIPTION

Hereinafter, embodiments of the present disclosure are described in detail with reference to drawings. It should be noted that, in assigning reference numerals to components in the drawings, the same components are given the same numerals as much as possible, even if they are shown in different drawings. Furthermore, in describing the present disclosure, detailed explanations of well-known components or functions may be omitted if they are deemed to obscure the gist of the disclosure.

In describing the components of the present disclosure, terms such as first, second, A, B, (a), (b), and the like may be used. These terms are merely intended to distinguish one component from another, and the essence, sequence, or order of the components are not limited by the terms. Furthermore, when a component is described as being “connected”, “coupled”, or “interfaced” to another component, it should be understood that the component may be directly connected or interfaced to another component or that the component may also be “connected”, “coupled”, or “interfaced” to another component via yet another component provided therebetween. When a controller, module, component, device, element, unit, part, portion, “-er,” or the like of the present disclosure is described as having a purpose or performing an operation, function, or the like, the controller, module, component, device, element, unit, part, portion, “-er,” or the like should be considered herein as being “configured to” meet that purpose or to perform that operation or function. Each controller, module, component, device, element, unit, part, portion, “-er,” and the like may separately embody or be included with a processor and a memory, such as a non-transitory computer readable media, as part of the apparatus.

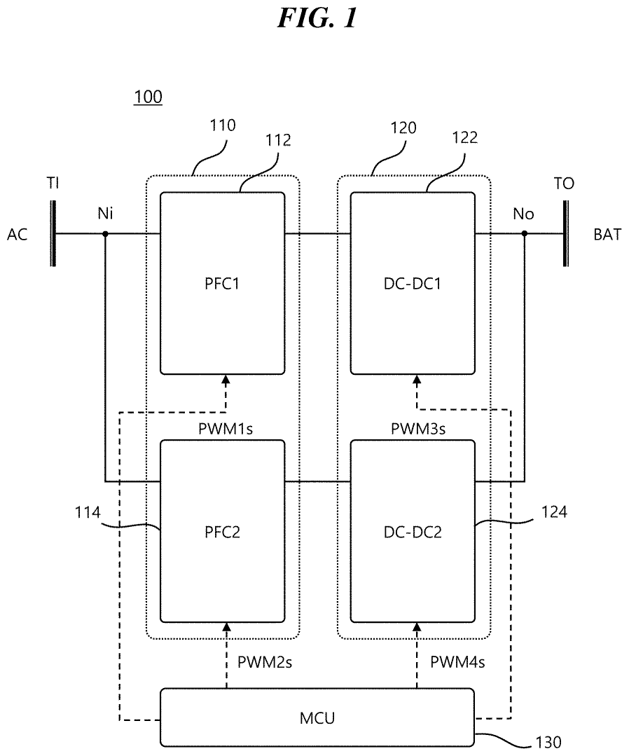

FIG. 1 is a configuration diagram of a converter according to an embodiment.

Referring to FIG. 1, the converter 100 may include a power factor correction (PFC) power stage 110, a DC/DC power stage 120, and a converter controller 130.

The converter 100 may be an on-board charger (OBC). When the converter 100 is an OBC, the load connected to the converter 100 may be a battery (BAT).

The converter 100 may be an on-board charger (OBC). The converter 100 may be a power conversion device installed in an electric vehicle, capable of converting alternating current (AC) electricity supplied from an external power source into direct current (DC) electricity to provide the power required for battery charging. The OBC may monitor the battery's charging status and control the charging current and voltage to prevent damage caused by overcharging or overcurrent. Additionally, the OBC may be designed to operate reliably under various input voltage conditions, and may include a power factor correction (PFC) function to reduce interference with a power grid.

The load connected to the converter 100 may be a battery (BAT). The battery (BAT) may serve as a primary energy storage device in an electric vehicle, and lithium-ion based battery cells may be commonly used. The battery (BAT) stores the power converted by the converter 100, and the stored energy may be used to drive the electric vehicle's motor and supply power to other electronic devices. The battery (BAT) may be designed to repeat charging and discharging processes, and a battery management system (BMS) may be used to monitor conditions such as temperature, voltage, and current.

In the converter 100, the PFC power stage 110 may receive alternating current power and convert it into direct current power. The DC/DC power stage 120 may regulate the voltage or current level of the direct current power supplied from the PFC power stage 110 and provide it to the load.

The DC/DC power stage 120 may include a plurality of DC/DC converting circuits 122 and 124. The DC/DC converting circuits 122 and 124 may be power conversion circuits capable of converting the voltage or current of the input direct current power to generate a voltage or current suitable for the load. These circuits may be designed to improve power transfer efficiency and adjust power according to the requirements of the load.

The DC/DC converting circuits 122 and 124 may be step-down converting circuits which convert the output voltage to a level lower than the input voltage. The step-down converting circuits may primarily employ a buck converter structure, and may convert the input voltage into a lower voltage suitable for the load through controlled switching operations. This conversion may minimize power loss, and may enable stable power supply within a voltage acceptance range of the load.

The DC/DC converting circuits 122 and 124 may be step-up converting circuits which convert the output voltage to a level higher than the input voltage. The step-up converting circuits may primarily employ a boost converter structure and may convert a low input voltage into a higher output voltage by utilizing switching operations and energy storage components. This circuit may be designed to provide the voltage required for the load even when the input voltage is low.

The DC/DC converting circuits 122 and 124 may be designed not only for step-down and step-up conversion, but also to support bidirectional power conversion. In such cases, they may include a function for adjusting voltage and current according to the direction of power flow.

The PFC power stage 110 may include a plurality of PFC circuits 112 and 114, and in this case, the DC/DC converting circuits 122 and 124 may operate in connection with the PFC circuits 112 and 114, respectively.

The PFC circuits 112 and 114 are circuits that receive alternating current power and convert it into direct current power. These circuits may rectify and filter alternating current (AC) power inputted from an external source to convert it into direct current (DC) power that can be used for electrical loads. The PFC circuits 112 and 114 may include a function for correcting power factors by adjusting the phases of the input current and input voltage during the power conversion process.

The PFC circuits 112 and 114 may be designed to adjust the waveform of the input current so that it remains in phase with the input voltage. This enables efficient use of power supplied from the power grid and helps reduce power loss and electromagnetic interference. To implement such power factor correction, the PFC circuits 112 and 114 may adopt an active PFC method.

In the case of the active PFC method, the PFC circuits 112 and 114 may include switches, and the converter controller 130 may control these switches to dynamically adjust the input current and perform precise power factor correction.

A plurality of switches may be arranged in the PFC circuits 112 and 114 and the DC/DC converting circuits 122 and 124. The switches may include, for example, Metal-Oxide-Semiconductor Field-Effect Transistors (MOSFETs), Insulated Gate Bipolar Transistors (IGBTs), or Bipolar Junction Transistors (BJTs).

A MOSFET is a device that can control the current between drain and source by applying a voltage between gate and source. The MOSFET may be a voltage-controlled device, and channel conductivity may be adjusted according to the voltage applied to the gate. The drain-source current is determined by the gate voltage, and due to their excellent switching characteristics, the MOSFET is widely used in switching applications.

An IGBT is a device that combines the characteristics of MOSFET and BJT, and it may control the collector-emitter current by applying a voltage between gate and emitter. The IGBT is capable of handling high voltages, and its structure may possess the input characteristics of MOSFET and the output characteristics of BJT. Due to these characteristics, the IGBT can be used in applications.

A BJT is a device including three terminals: base, collector, and emitter, that controls the current between collector and emitter by applying a base current. The BJT is a current-controlled device, and the collector current may be amplified by the base current. Due to this amplification characteristic, the BJT can be used in current amplifiers and has the advantage of handling high current in specific applications.

The converter controller 130 may control these switches using Pulse Width Modulation (PWM) . Through this PWM control, the converter controller 130 may control the duty cycle of each switch and control the switching period or switching frequency of each switch.

PWM control may be a method of generating desired output voltage or current by adjusting the ON time and OFF time of the switches. Through this PWM control, the converter controller 120 may adjust the duty cycle of each switch. The duty cycle represents the ratio of the time during which the switch is ON, and can be used to control the amplitude of the output power.

The converter controller 130 may control not only the duty cycle but also the switching period or switching frequency of each switch. The switching period may refer to the time it takes for a switch to turn on and off once, and the switching frequency may refer to the number of times a switching operation is repeated per second. Controlling the switching period or frequency can affect the quality of the output power and the efficiency of power conversion and may also be related to thermal management of power devices.

The converter controller 130 may include a circuit or algorithm capable of monitoring input signals of voltage, current, and temperature and generating PWM signals based on the input signals, in order to adjust the states of the switches in real time.

Alternating current (AC) power may be supplied to an input terminal TI of the converter 100, and a load—for example, a battery BAT-may be connected to an output terminal TO of the converter 100. Furthermore, an input node Ni may be formed at the input terminal TI, and an output node No may be formed at the output terminal TO.

The first PFC circuit 112 and the second PFC circuit 114 may share the input node Ni, and the first DC/DC converting circuit 122 and the second DC/DC converting circuit 124 may share the output node No. The first PFC circuit 112 may convert the alternating current power formed at the input node Ni into direct current power and may supply it to the first DC/DC converting circuit 122, and the first DC/DC converting circuit 122 may then convert the voltage or current of the direct current power and supply it to the output node No. The second PFC circuit 114 may convert the alternating current power formed at the input node Ni into direct current power and may supply it to the second DC/DC converting circuit 124, and the second DC/DC converting circuit 124 may then convert the voltage or current of the direct current power and supply it to the output node No.

For the power conversion of each circuit 112, 114, 122, and 124, the converter controller 130 may output a first PWM signal (PWM1s) to the first PFC circuit 112 and may output a second PWM signal (PWM2s) to the second PFC circuit 114. Additionally, the converter controller 130 may output a third PWM signal (PWM3s) to the first DC/DC converting circuit 122 and a fourth PWM signal (PWM4s) to the second DC/DC converting circuit 124.

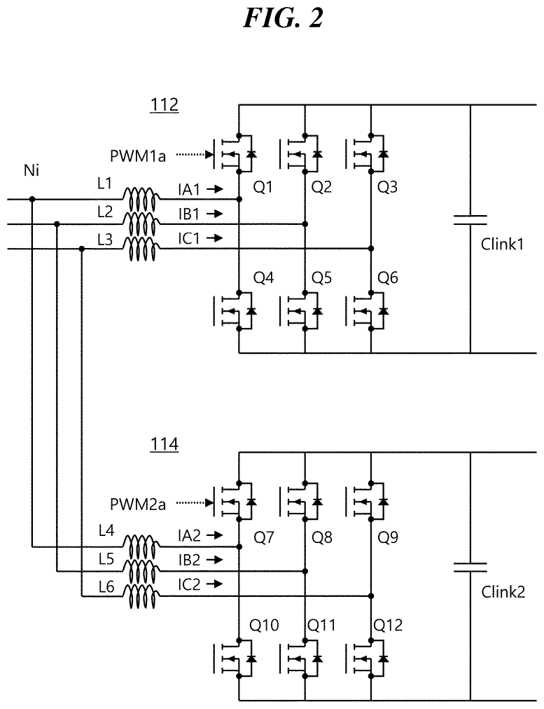

FIG. 2 is a configuration diagram of a PFC power stage according to one embodiment.

Referring to FIG. 2, the PFC power stage may include a first PFC circuit 112 and a second PFC circuit 114. The first PFC circuit 112 and the second PFC circuit 114 may share the input node Ni.

The power supplied to the input node Ni may be three-phase power. Depending on the embodiment, the power supplied to the input node Ni may be single-phase power; however, for the convenience of explanation, it is described hereinafter as three-phase power being supplied to the input node Ni.

An input filter may be disposed in each PFC circuit 112 and 114. A first inductor L1 may be disposed on A-phase of the first PFC circuit 112, a second inductor L2 may be disposed on B-phase thereof, and a third inductor L3 may be disposed on C-phase thereof. A fourth inductor L 4 may be disposed on A-phase of the second PFC circuit 114, a fifth inductor L5 may be disposed on B-phase thereof, and a sixth inductor L6 may be disposed on C-phase thereof.

In each PFC circuit 112 and 114, a pair of switches may be connected to each phase. In the first PFC circuit 112, a first switch Q1 and a fourth switch Q4 may be disposed on A-phase, a second switch Q2 and a fifth switch Q5 may be disposed on B-phase, and a third switch Q3 and a sixth switch Q6 may be disposed on C-phase. In the second PFC circuit 114, a seventh switch Q7 and a tenth switch Q10 may be disposed on A-phase, an eighth switch Q8 and an eleventh switch Q11 may be disposed on B-phase, and a ninth switch Q9 and a twelfth switch Q12 may be disposed on C-phase.

The converter controller may supply PWM signals to the gates of the switches Q1 to Q12 to control the ON/OFF of the switches Q1 to Q12. For example, the converter controller may supply a first PWM a-phase signal (PWM1a) to the gate of the first switch Q1 to control the ON/OFF of the first switch Q1. The converter controller may supply a second PWM a-phase signal (PWM2a) to the gate of the seventh switch Q7 to control the ON/OFF of the seventh switch Q7.

Based on the ON/OFF of the switches Q1 to Q12, phase currents IA1, IB1, IC1, IA2, IB2, and IC2 may be converted into direct current and temporarily stored in DC link capacitors Clink1 and Clink2. For example, based on the ON/OFF of the switches Q1 through Q6, the phase currents IA1, IB1, and IC1 of the first PFC circuit 112 may be converted into direct current and temporarily stored in the first DC link capacitor Clink1. Based on the ON/OFF of the switches Q7 through Q12, the phase currents IA2, IB2, and IC2 of the second PFC circuit 114 may be converted into direct current and temporarily stored in the second DC link capacitor Clink2.

In this instance, the switches Q1 to Q6 of the first PFC circuit 112 and the switches Q7 to Q12 of the second PFC circuit 114 may operate in such a manner that control values have coherence. Here, coherence may mean that the control values are updated in the same cycle.

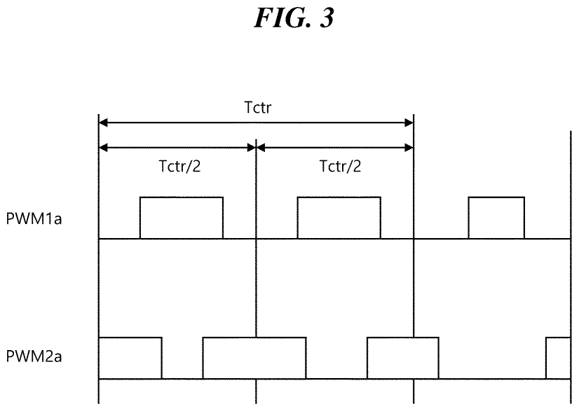

FIG. 3 is a waveform diagram of a first PWM a-phase signal and a second PWM a-phase signal according to one embodiment.

Referring to FIG. 3, the first PWM a-phase signal (PWM1a) and the second PWM a-phase signal (PWM2a) may be updated for the same control period Tctr. For example, the duty cycles of the first PWM a-phase signal (PWM1a) and the second PWM a-phase signal (PWM2a) may be changed for the same control period Tctr. In the example shown in FIG. 3, the first PWM a-phase signal (PWM1a) and the second PWM a-phase signal (PWM2a) have a phase difference of 180 degrees, but the control periods Tctr of the two signals may be substantially the same.

In the example of FIG. 3, one control period Tctr may include two switching periods Tctr/2, and both the first PWM a-phase signal (PWM1a) and the second PWM a-phase signal (PWM2a) may have the same switching period Tctr/2.

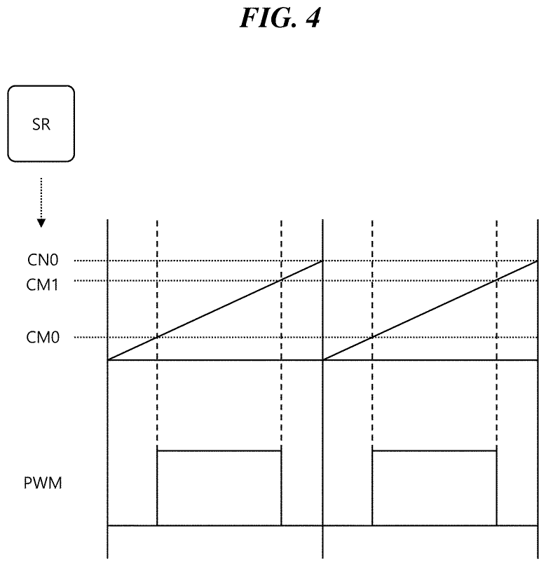

FIG. 4 is a diagram illustrating elements that determine control values of each PWM signal in one embodiment.

Referring to FIG. 4, the control values of a PWM signal may include duty cycle and period. The converter controller may perform PWM control on each switch to control the output of each PFC circuit, where PWM control may refer to controlling the duty cycle and period of a PWM signal.

Meanwhile, the converter controller may use a timer and registers to control the duty cycle and period of a PWM signal.

For example, the converter controller may include a timer, and the period of a PWM signal may be determined by comparing the timer value with the value of a first CN register CN0. The timer may count up from an initial value (e.g., 0), incrementing at fixed intervals, and when its value becomes equal to the value of the first CN register CN0, it may return to the initial value. In this method, the period of the PWM signal may be determined by the value of the first CN register CN0.

As another example, the converter controller may set the rising edge of the PWM signal when the timer value becomes equal to the value of the first CM register CM0, and the converter controller may set the falling edge of the PWM signal when the timer value becomes equal to the value of the second CM register CM1. In this method, the duty cycle of the PWM signal may be determined by the value of the first CM register CM0 and the value of the second CM register CM1.

The converter controller may calculate control values (e.g., duty cycle and period) for each PWM signal and then may calculate the register values based on those control values. The controller may then update the registers with the calculated values to control each PWM signal.

At this time, the converter controller may use a shadow register SR to synchronize the timing at which the registers are updated and controlled with coherence. After calculating the control values (e.g., duty cycle and period) for each PWM signal, the converter controller may store these values first in the shadow register SR. Then, the converter controller may be configured so that the values stored in the shadow register SR are transmitted to the registers CN0, CM0, and CM1 at the start of the next control period. This method prevents the registers from being updated arbitrarily and helps maintain them with coherence.

The converter controller may include a core for calculation. This core may execute a control algorithm to calculate control values for each PWM signal. Based on these control values, it may derive register values and then update the shadow register.

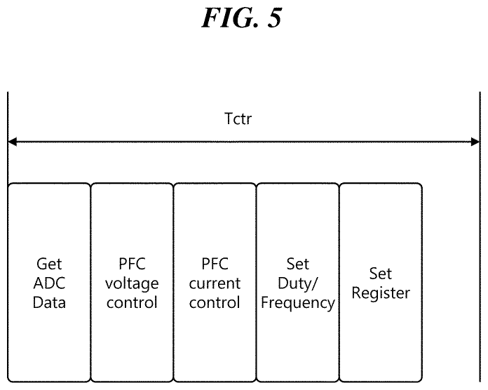

FIG. 5 illustrates an example diagram showing a control process performed by a single core during one control period.

Referring to FIG. 5, in each control period, the core may perform processes such as a process of acquiring sensing values from an Analog-Digital Converter (ADC), a voltage control process, a current control process, a control value setting process, and a register configuration process.

The converter controller may include a plurality of ADC channels. Each ADC channel may sense the current of each phase, the voltage of a DC link capacitor, the voltage of an output node, etc. and convert them into digital values. The core may acquire sensing values from the individual ADC channels during an initial time segment of each control period.

The core may perform PFC voltage control based on the acquired ADC sensing values. For example, the core may perform a PFC voltage control process to execute a control algorithm designed to compare a sensed voltage value of the DC link capacitor with a reference voltage value and minimize the difference between the two values.

The core may perform PFC current control based on the ADC sensing values and the result values of the PFC voltage control process. For example, the core may perform a PFC current control process to execute a control algorithm that uses the sensed current value of each phase and the result value calculated in the PFC voltage control process to maintain the current value of each phase at a consistent level.

The core may calculate control values for Pulse Width Modulation (PWM) signals for each switch—for example, duty cycle and period-based on the result values of the PFC current control process and may store the calculated values in a predefined data variable.

The core may read the values stored in the predefined data variable, may calculate the register values based on these values, and may configure the registers with the calculated values.

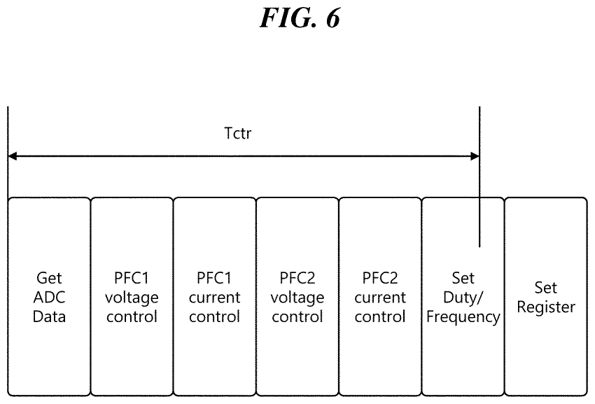

FIG. 6 is a diagram illustrating a problem that may arise when a single core simultaneously controls two PFC (power factor correction) circuits during one control period.

Referring to FIG. 6, a single core may control two PFC circuits. In this case, the core needs to calculate control values separately for each PFC circuit, which may require performing the PFC voltage control process and the PFC current control process twice.

After performing the process of acquiring sensing values from an Analog-to-Digital Converter (ADC), the core may first execute the voltage control process and current control process for the first PFC circuit. Then, the core may perform the voltage control process and current control process for the second PFC circuit. Once the control values for each PFC circuit have been calculated, the core may perform the control value setting process and the register configuration process.

However, there is a possibility that a single core may not be able to complete all these processes within a single control period. In particular, if the core is optimized for controlling a single PFC circuit, attempting to control two or more PFC circuits with the same core may result in a failure to perform every process within one control period.

To address this issue, the converter controller according to one embodiment may use two cores to control each PFC circuit independently.

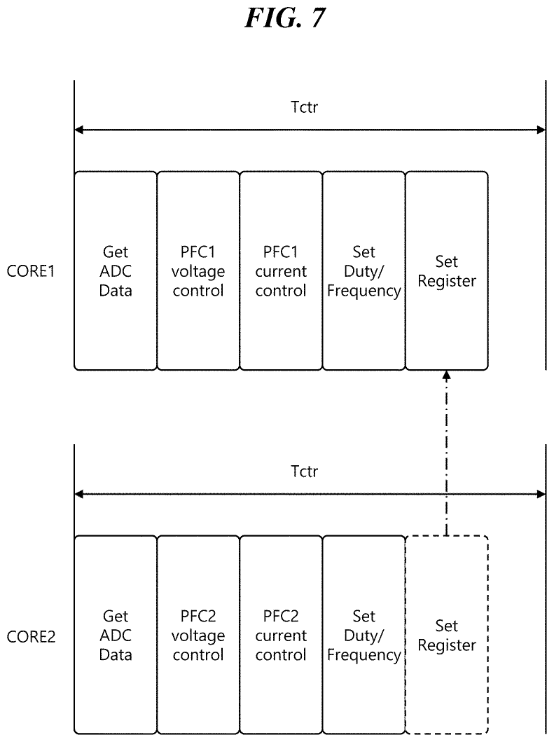

FIG. 7 is a diagram illustrating how two cores in a converter controller according to one embodiment control respective PFC circuits.

Referring to FIG. 7, the first core may perform a process of acquiring sensing values from the Analog-to-Digital Converter (ADC) connected to the first PFC circuit. The first core may then perform the voltage control process and current control process for the first PFC circuit. Additionally, the first core may perform the process of setting the control values required for the first PFC circuit and updating the registers.

The second core may perform a process of acquiring sensing values from the ADC connected to the second PFC circuit. Then, the second core may execute the voltage control process and current control process for the second PFC circuit. Afterward, the second core may perform the control value setting process required for the second PFC circuit.

At this time, if the second core independently performs the register configuration process, there is a possibility that a problem may arise. When the first and second cores each perform the register configuration process, one core may properly configure the registers, while the other core may fail to do so. For example, the first core may complete the register configuration properly, but the second core may fail to complete the process.

In such cases, the first and second PFC circuits may be controlled without maintaining data coherence. As a result, control values such as switching period may not be synchronized, potentially causing excessive current to flow through a particular circuit.

To address this issue, a method may be applied in which a single core (e.g., the first core) configures registers for both of the two PFC circuits. The first core may read the control values calculated by the second core, calculate the register values based on the calculated control values, and then configure the registers for the second PFC circuit.

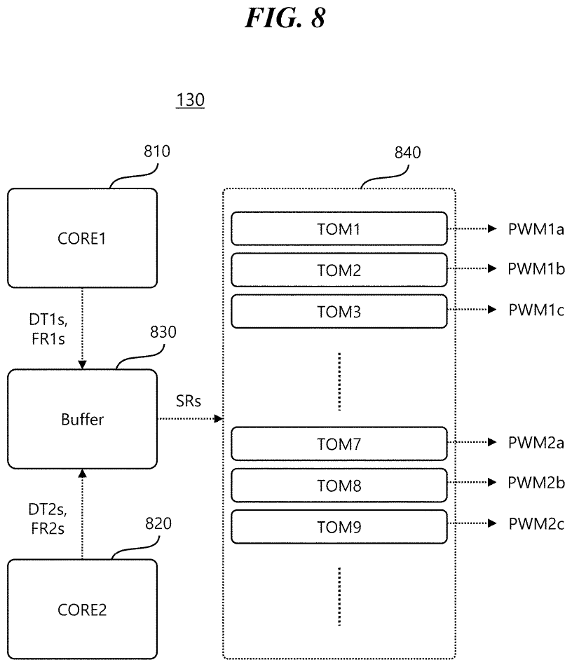

FIG. 8 is a configuration diagram of a converter controller according to one embodiment.

Referring to FIG. 8, the converter controller 130 may include a first core 810, a second core 820, a buffer 830, and a timer module 840.

The converter controller 130 may be configured in the form of a micro-controller unit (MCU).

The MCU is an integrated circuit for an embedded system that may include one or more processor cores. These cores may have a structure capable of performing 8-bit, 16-bit, 32-bit, or higher bit data processing. Depending on the requirements of a specific application, the MCU may be designed to include multiple 32-bit cores. Such a design may offer the potential for parallel processing and high-performance computational tasks.

The MCU may be configured as a hardware and software platform for use in automotive and industrial applications. The MCU may function in environments that require high-performance computation, communication, and data processing. Through this, the MCU may be used to control various sensors and actuators and to execute complex control algorithms. The MCU may contribute to enhancing system stability and efficiency by generating control signals or processing data.

The MCU may support functional safety at the ISO 26262 Automotive Safety Integrity Level-D (ASIL-D) level. This standard defines the requirements necessary to ensure safe operation in automotive applications. In accordance with these requirements, the MCU may include fault diagnosis, error detection, and recovery functions. Through this, it is possible to meet the hardware and software design elements needed to enhance the safety of automotive systems.

The MCU may comply with the Automotive Open System Architecture (AUTOSAR) 4.2 standard. This standard defines the software architecture of automotive electronic control units (ECUs), and the MCU may perform integrated functions within this architecture. By complying with AUTOSAR, the MCU may provide a software platform that ensures interoperability among various suppliers and systems.

The MCU may include communication interfaces, data processing capability, and security features. The communication interfaces may include Controller Area Network (CAN), Local Interconnect Network (LIN), FlexRay, and Ethernet, through which the MCU can exchange data with an external device. The data processing capability may vary depending on the performance of the cores included in the MCU and the memory size. Additionally, the MCU may provide hardware security features such as an encryption module or security authentication.

The MCU may perform sensor data collection and processing and actuator control through various input and output interfaces. This enables the MCU to support conversion tasks between the physical world and digital signals. Additionally, the MCU may include functions such as Analog-to-Digital Converter (ADC), Digital-to-Analog Converter (DAC), and Pulse Width Modulation (PWM), allowing for various control and conversion tasks.

The MCU may include built-in memory and storage. Program code and data may be stored using embedded flash memory or Electrically Erasable Programmable Read-Only Memory (EEPROM), and Random Access Memory (RAM) may be included to process data required during execution. This memory architecture may be designed in various ways to meet the requirements of the application.

The first core 810 and the second core 820 each may be one of the plurality of cores included in the MCU.

The first core 810 may acquire ADC sensing values in each control period, and may perform voltage control and current control processes for the first PFC circuit to calculate PWM control values—for example, first duty cycle values DT1s and first period values FR1s—for the first switches included in the first PFC circuit. The first core 810 may then store the control values DT1s and FR1s for the first switches in a first data variable included in the buffer 830. Here, there may be a plurality of first data variables, and the first core 810 may select one of the plurality of first data variables and store the control values DT1s and FR1s for the first switches in the selected first data variable.

The second core 820 may acquire ADC sensing values in each control period and may perform voltage control and current control processes for the second PFC circuit to calculate PWM control values—for example, second duty cycle values DT2s and second period values FR2s—for the second switches included in the second PFC circuit. The second core 820 may then store the control values DT2s and FR2s for the second switches in a second data variable included in the buffer 830. Here, there may be a plurality of second data variables, and the second core 820 may select one of the plurality of second data variables and store the control values DT2s and FR2s for the second switches in the selected second data variable.

Here, the buffer 830 may be shared by the first core 810 and the second core 820. Accordingly, the first core 810 may access not only the first data variable but also the second data variable.

The first core 810 may check the data variables - for example, the first data variable and the second data variable - and configure registers for PWM signal output to the first and second switches based on the values of the data variables. At this time, the first core 810 may set the values of the shadow registers SRs included in the timer module 840.

The timer module 840 may have the form of a GTM (Generic Timer Module).

The GTM may be a hardware module capable of performing complex timing and event control tasks in embedded systems. This module may include various channels, and can be used in applications that require precise time-based control. The GTM may provide hardware-based timing management functions that support tasks such as input signal processing, output signal generation, and timing control.

The GTM may include submodules. These submodules may include sub-structures such as Timer Output Module (TOM), Advanced Timer Output Module (ATOM), Timer Input Module (TIM), and Time Base Unit (TBU). TOM is a module that supports Pulse Width Modulation (PWM) signal generation and may be designed to allow independent control for each channel. ATOM is a timing control module that can provide higher precision and flexibility than TOM. TIM may process input signals to detect timing events or capture time data. TBU provides a time base that serves as a reference for timer operation.

The GTM may include an integrated clock management mechanism. A Clock Management Unit (CMU) may provide clock signals suitable for each submodule of the module, and may control the frequency and accuracy of the timer. Through this, the GTM may support operations suitable for various timing requirements.

The GTM may support multi-channel operation. This allows the timer module 840 to process multiple input and output signals simultaneously, with each channel being independently configured and controlled.

The timer module 840 may include a plurality of TOMs (TOM1, TOM2, TOM3, . . . TOM7, TOM8, TOM9, . . . ). Each TOM channel (TOM1, TOM2, TOM3, . . . , TOM7, TOM8, TOM9, . . . ) may output a single PWM signal (PWM1a, PWM1b, PWM1c, . . . , PWM2a, PWM2b, PWM2c, . . . ) to control the on/off of a corresponding switch. For example, the first TOM channel (TOM1) may output a first PWM a-phase signal (PWM1a), the second TOM channel (TOM2) may output a first PWM b-phase signal (PWM1b), and the third TOM channel (TOM3) may output a first PWM c-phase signal (PWM1c). The seventh TOM channel (TOM7) may output a second PWM a-phase signal (PWM2a), the eighth TOM channel (TOM8) may output a second PWM b-phase signal (PWM2b), and the ninth TOM channel (TOM9) may output a second PWM c-phase signal (PWM2c).

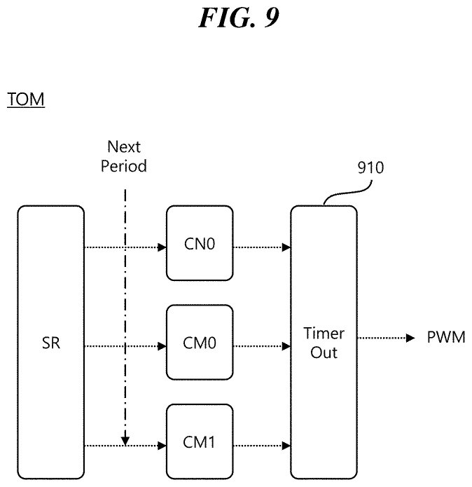

FIG. 9 is a configuration diagram of a TOM channel according to an embodiment.

Referring to FIG. 9, the TOM channel may include registers such as a shadow register (SR), a first CN register (CN0: Compare Number Register 0), a first CM register (CM0: Compare Match Register 0), and a second CM register (CM1: Compare Match Register 1). The TOM channel may perform timer-based signal processing through these registers. Each register may perform a specific function in the process of generating or outputting a PWM (Pulse Width Modulation) signal.

The shadow register SR may be used as a space for temporarily storing values during operation. It helps prevent immediate impact on timer output when the register values are changed, and it provides a structure that allows new values to be applied reliably. This allows for a design that contributes to maintaining signal continuity and stability in the process of generating PWM signals.

The first CN register CN0 may be configured as a register for storing or comparing the current value of a timer. It may be used to check the current state of the timer or determine whether the value of the timer has reached a specific reference. CN0 stores values related to a timer period, and may serve as a reference value needed to generate a PWM signal period.

The first CM register CM0 and the second CM register CM1 may be used to store a reference value to be compared with a value of the timer. CM0 may be used to switch the PWM signal to a high state or trigger a specific operation when the value of the timer reaches a certain point. CM1 may be used to switch the PWM signal to a low state or perform another operation when the value of the timer reaches another specific point. The duty cycle and period of the PWM signal may be determined based on the values of these two registers.

The TOM channel may include an output unit 910 that generates PWM signals based on the setting values of the registers. The output unit may process timer events based on the register values and generate PWM signals and transmit them to an external system. The output unit, which is a block that is designed at the hardware level, is controlled by the register values, and may operate in a way that ensures the accuracy and coherence of the PWM signals.

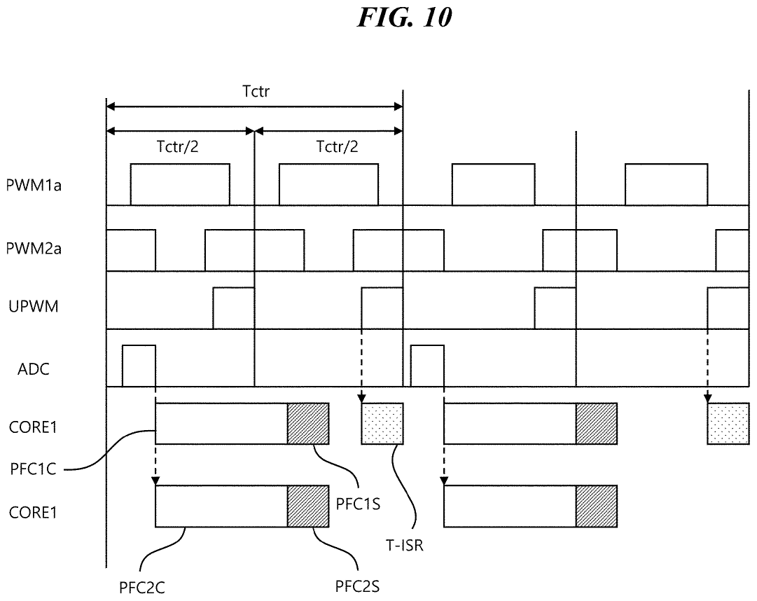

FIG. 10 is a diagram illustrating a procedure for cores to perform processes and waveforms of primary signals according to one embodiment.

Referring to FIG. 10, the ADC may perform sensing during an initial time segment of each control period. Then, based on a sensing-completion interrupt signal from the ADC, the first core may perform a first control process (PFC1C), and the second core may perform a second control process (PFC2C).

In the first control process (PFC1C), the first core may calculate the PWM control values for the first switches included in the first PFC circuit. In the first control process (PFC1C), the first core may perform the process of acquiring sensing values from the ADC for the first PFC circuit, the voltage control process, and the current control process and then calculate the PWM control values for the first switches. The first control process (PFC1C) may be performed for each control period.

In the second control process (PFC2C), the second core may calculate the PWM control values for the second switches included in the second PFC circuit. In the second control process (PFC2C), the second core may perform the process of acquiring sensing values from the ADC for the second PFC circuit, the voltage control process, and the current control process and then calculate the PWM control values for the second switches. The second control process (PFC2C) may be performed for each control period.

After performing the first control process (PFC1C), the first core may store the calculated PWM control values for the first switches in the first data variable located in the buffer (PFC1S). After performing the second control process (PFC2C), the second core may store the calculated PWM control values for the second switches in the second data variable located in the buffer (PFC2S).

Based on the values of the data variables stored in the buffer, the first core may configure registers for PWM signal output to the first switches and configure registers for PWM signal output to the second switches (T-ISR). This process may be performed in the top-level ISR (Interrupt Service Routine) of the first core. In the top-level ISR, the first core may configure the registers for PWM signal output to the first switches and the registers for PWM signal output to the second switches.

The top-level Interrupt Service Routine (ISR) may be invoked a certain amount of time before the start of a new control period, and the top-level ISR may be finished before the start of the new control period. A UPWM may be generated for every switching period Tctr/2, and the next switching period may start at the falling edge of the UPWM. The top-level ISR may be invoked at the rising edge of a UPWM generated for the second switching period of one control period Tctr. The first core may configure the registers for PWM signal output to the first switches and the registers for PWM signal output to the second switches, based on the values of the data variables stored in the buffer until the start of the next control period.

Meanwhile, if the PWM control values for the first switches and the PWM control values for the second switches are not properly stored in the first and second data variables before the first core configures the registers for PWM signal output to the first switches and the registers for PWM signal output to the second switches, data coherence may not be guaranteed.

The converter controller according to one embodiment may adopt a multi-buffer method or a dual-buffer method to ensure data coherence.

In the dual buffer method, two first data variables and two second data variables may be located in a buffer. The first core may select one of the two first data variables and store PWM control values in the selected first data variable. The second core may select one of the two second data variables and store PWM control values in the selected second data variable. The first core may select and use alternately between the two first data variables. The second core may select and use alternately between the two second data variables.

The multi-buffer method may be viewed as an extended form of the dual-buffer method. If the multi-buffer method uses two data variables, it may serve as the dual-buffer method.

In the multi-buffer method, a plurality of first data variables may be located in a buffer. For example, there may be two or three first data variables. Also, a plurality of second data variables may be located in the buffer. Data variables of each type may be configured as an array. For example, first data variables may be configured in the form of DATA1[N], and second data variables may be configured in the form of DATA2[N]. Here, DATA1 is the variable name for the first data variables, and DATA2 is the variable name for the second data variable. The number N of arrays may be a natural number equal to or greater than 2.

The first core may select and use one of the plurality of first data variables, and the second core may select and use one of the plurality of second data variables. The first core and the second core may select data variables according to sequence numbers. Index variables may be used to manage the sequence numbers. For example, the first core may select a first data variable with a sequence number corresponding to the value of a first index variable, among the plurality of first data variables, and may store PWM control values in the selected data variable. The second core may select a second data variable with a sequence number corresponding to the value of a second index variable, among the plurality of second data variables, and may store PWM control values in the selected data variable.

Once the storing is completed, the value of the index variable may be incremented. The first core may store PWM control values in the selected first data variable and then increment the value of the first index variable by one. The second core may store PWM control values in the selected second data variable and then may increment the value of the second index variable by one. If the value of the index variable reaches the number of data variables, for example, N, the value of the index variable may be reset to its initial value, for example, 0. For example, in the dual-buffer method, the value of the index variable may be changed in the order 0→1→0. If the number N of data variables is 3, the value of the index variable may be changed in the order 0→1→2→0.

Such index variables may also be located in a buffer shared by the first core and the second core. The first core may check one data variable selected according to a sequence number by the index variable. The first core may either check the PWM control values from the data variable corresponding to the sequence number indicated by the value of the index variable or check the PWM control values from the data variable corresponding to a sequence number preceding the sequence number indicated by the value of the index value. After storing PWM control values in a data variable, the first and second cores may change the index variable. At this time, a sequence number selected for the current control period or a sequence number to be selected for the next control period may be stored in the index variable. Once the sequence number selected for the current control period is stored in the index variable, the first core may check the PWM control values from the data variable corresponding to the sequence number indicated by the value of the index variable. Then, once the sequence number to be selected for the next control period is stored in the index variable, the first core may check the PWM control values from the data variable corresponding to a sequence number preceding the sequence number indicated by the value of the index variable. Based on the checked PWM control values, the first core may then configure the registers for PWM signal output to the first switches and the registers for PWM signal output to the second switches.

In one embodiment, the first core manages multiple data variables not only for the second core but also for itself. This is because the process of configuring registers is performed in the top-level ISR. When the top-level ISR is invoked, other processes may be interrupted. In this case, if the process of storing PWM control values in data variables is interrupted, the data variables may not be fully stored in the first core. For this reason, both the first and second cores may manage the data variables using either a multi-buffer method or a dual-buffer method.

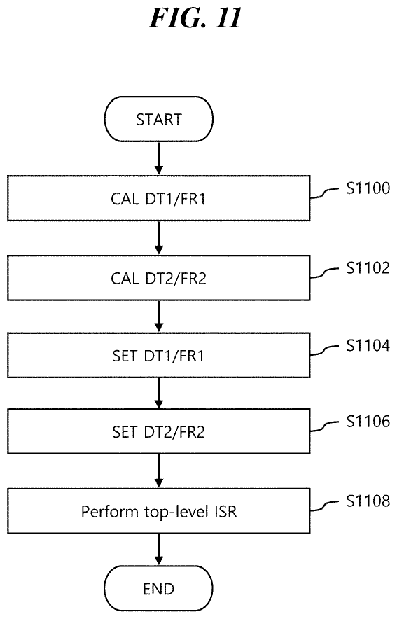

FIG. 11 is a flowchart illustrating a converter control method according to one embodiment.

Referring to FIG. 11, the first core may calculate PWM control values for the first switches included in the first PFC circuit (S1100). The PWM control values may include at least one of a value indicating the duty cycle of the PWM signal and a value indicating the period of the PWM signal.

Then, the second core may calculate PWM control values for the second switches included in the second PFC circuit (S1102).

Then, the first core may store the PWM control values for the first switches in one of a plurality of first data variables selected according to a sequence number (S1104). The plurality of first data variables may be configured as an array, and one of the data variables in the array may be selected according to the sequence number. For example, the sequence number may be stored in an index variable, and a first data variable corresponding to the value of the index variable may be selected from the array of first data variables. If there are two first data variables, the first core may store the PWM control values for the first switches in one of the two first data variables. These two data variables may be alternately selected and used.

Then, the second core may store the PWM control values for the second switches in one of a plurality of second data variables selected according to a sequence number (S1106). The plurality of second data variables may be configured as an array, and one of the data variables in the array may be selected according to the sequence number. For example, the sequence number may be stored in an index variable, and a second data variable corresponding to the value of the index variable may be selected from the array of second data variables. If there are two second data variables, the second core may store the PWM control values for the second switches in one of the two second data variables. These two data variables may be alternately selected and used.

Then, the first core may configure registers for PWM signal output to the first switches based on the value of the selected first data variable and may configure registers for PWM signal output to the second switches based on the value of the selected second data variable (S1108).

The first core and the second core may store, in an index variable, a sequence number selected for the current control period or a sequence number to be selected for the next control period. Through this index variable, the first core may check the data variable in which the PWM control values are stored for the current control period and may configure the registers for PWM signal output based on the value of that data variable.

This step S1108 may be performed in the top-level ISR of the first core. This top-level ISR may be invoked a certain amount of time before the start of a new control period, and may be finished before the start of the new control period.

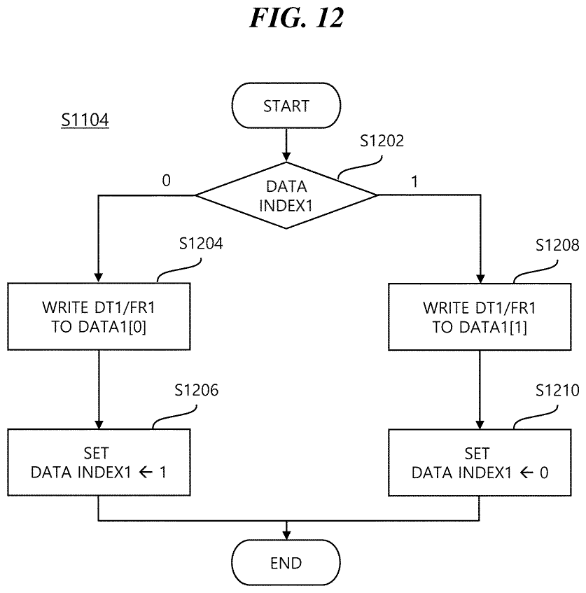

FIG. 12 is a detailed flowchart of step S1104 in the flowchart in FIG. 11.

Referring to FIG. 12, the first core may check the value of a first index variable DATA_INDEX1 (S1202). Based on the value of the first index variable, the first core may select a data variable in which to store the PWM control values for the first switches.

When the value of the first index variable is 0 (0 at S1202), the first core may select a first variable DATA1[0] among the plurality of first data variables. Then, the first core may store the PWM control values for the first switches—for example, a duty cycle value DT1 and/or a frequency value FR1—in the first variable DATA1[0] (S1204). The first core may change the value of the first index variable to 1(S1206).

When the value of the first index variable is 1 (1 at S1202), the first core may select a second first data variable DATA1[1] among the plurality of first data variables. Then, the first core may store the PWM control values for the first switches—for example, a duty cycle value DT1 and/or a frequency value FR1—in the second first data variable DATA1[1] (S1204). The first core may change the value of the first index variable to 0 (S1210).

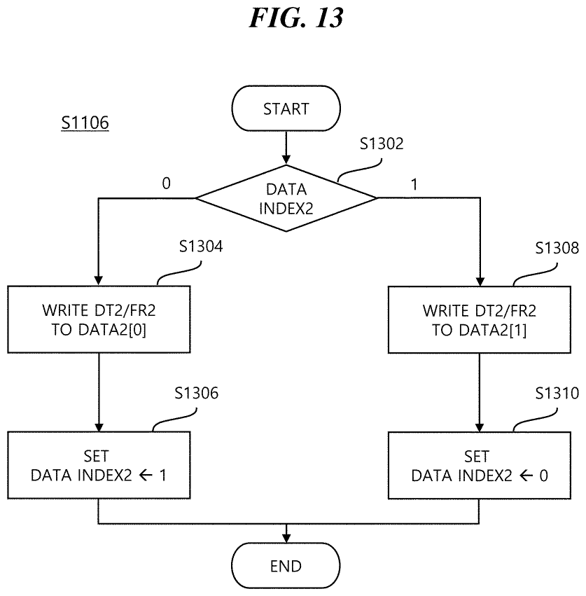

FIG. 13 is a detailed flowchart of step S1106 in the flowchart in FIG. 11.

Referring to FIG. 13, the second core may check the value of a second index variable DATA_INDEX2 (S1302). Based on the value of the second index variable, the second core may select a data variable in which to store the PWM control values for the second switches.

When the value of the second index variable is 0 (0 at S1302), the second core may select a first second data variable DATA2[0] among the plurality of second data variables. Then, the second core may store the PWM control values for the second switches—for example, a duty cycle value DT2 and/or a frequency value FR2—in the first second data variable (DATA2[0]) (S1304). The second core may change the value of the second index variable to 1(S1306).

When the value of the second index variable is 1 (1 at S1302), the second core may select a second variable DATA2[1] among the plurality of second data variables. Then, the second core may store the PWM control values for the second switches-for example, a duty cycle value DT2 and/or a frequency value FR2—in the second variable (DATA2[1]) (S1308). The second core may change the value of the second index variable to 0(S1310).

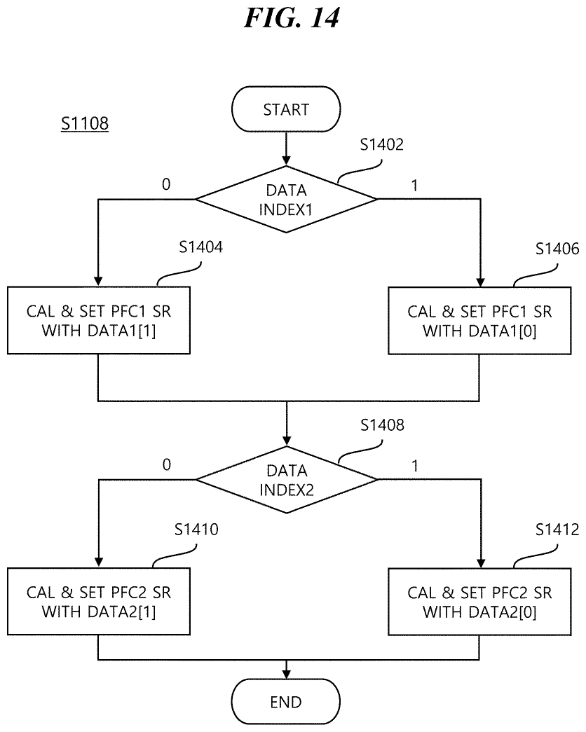

FIG. 14 is a detailed flowchart of step S1108 in the flowchart in FIG. 11.

Referring to FIG. 14, the first core may check the value of a first index variable DATA_INDEX1 (S1402). Based on the value of the first index variable, the first core may check one first data variable among the plurality of first data variables.

When the value of the first index variable is 0 (0 at S1402), the first core may select a second first data variable DATA1[1] among the plurality of first data variables. Then, the first core may configure the registers for PWM signal output to the first switches based on the value of the second first data variable DATA1[1] (S1404).

The step S1404, etc. of configuring the registers may include a step of calculating the values of the registers and a step of setting the registers to those values.

For example, the first core may calculate a first CN register value so as to correspond to a value indicating the period of a PWM signal included in a PWM control value. The first core may store the first CN register value in one shadow register corresponding to the first CN register. The value stored in the one shadow register may be transmitted to the first CN register at the start of the next control period.

As another example, the first core may calculate a first CM register value and a second CM register value so as to correspond to the duty cycle of a PWM signal included in a PWM control value. The first CM register value may be a value used for setting the rising edge of the PWM signal—for example, a rising edge time value, and the second CM register value may be a value used for setting the falling edge of the PWM signal—for example, a falling edge time value. Additionally, the first core may store the first CM register value in another shadow register corresponding to the first CM register and may store the second CM register value in yet another shadow register corresponding to the second CM register. The value stored in the another shadow register and the value stored in the yet another shadow register may be transmitted to the first CM register and the second CM register, respectively, at the start of the next control period.

In the step S1404, of configuring the registers, the first core may substantially configure shadow registers respectively corresponding to TOMs.

In step S1402, when the value of the first index variable is 1 (1 at S1402), the first core may select a first variable DATA1[0] among the plurality of first data variables. Then, based on the value of the first variable DATA1[0], the first core may configure the registers for PWM signal output to the first switches (S1406).

Then, the first core may check the value of the second index variable DATA_INDEX2 (S1408). Based on the value of the second index variable, the first core may check one of the plurality of second data variables.

When the value of the second index variable is 0 (0 at S1408), the first core may select a second variable DATA2[1] among the plurality of second data variables. Then, based on the value of the second variable DATA2[1], the first core may configure the registers for PWM signal output to the second switches (S1410).

When the value of the second index variable is 1 (1 at S1408), the first core may select a first second data variable DATA2[0] among the plurality of second data variables. Then, based on the value of the first second data variable DATA2[0], the first core may configure the registers for PWM signal output to the second switches (S1412).

As described above, according to the present disclosure, a plurality of PFC circuits may be controlled in synchronization. Furthermore, according to the present disclosure, it is possible to ensure data coherence when a plurality of PFC circuits is controlled by different cores.

As used herein, terms such as “include”, “comprise,” or “have” should interpreted as indicating the possibility of inclusion, unless explicitly stated otherwise and therefore should not be construed as excluding other components but rather as allowing the inclusion of additional components. All terms, including technical and scientific terms, should be interpreted as having the meanings commonly understood by those of ordinary skill in the art to which the present disclosure pertains, unless otherwise defined. Commonly used terms, such as those defined in dictionaries, should be interpreted in accordance with their contextual meaning in the relevant technical field, and unless expressly defined in the present disclosure, should not be interpreted in an idealized or overly formal sense.

The foregoing description is merely illustrative of the technical concept of the present disclosure, and those having ordinary skill in the art to which the disclosure pertains should understand that various modifications and alterations may be made without departing from the essential characteristics of the present disclosure. Accordingly, the embodiments disclosed herein are intended to explain, not to limit, the technical concept of the disclosure, and the scope of the technical concept should not be construed as being restricted by these embodiments. The scope of protection of the present disclosure shall be interpreted based on the claims below, and all technical concepts falling within an equivalent scope shall be construed as being included within the scope of rights of the present disclosure.

What is claimed is:

1. A converter controller comprising:
a first core configured, in each control period, to:
calculate pulse width modulation (PWM) control values for first switches included in a first power factor correction (PFC) circuit; and
configure registers for PWM signal output to the first switches; and
a second core configured, in each control period, to:
calculate PWM control values for second switches included in a second PFC circuit; and
store the PWM control values for the second switches in one of a plurality of second data variables selected according to a sequence number,
wherein the first core is further configured to configure registers for PWM signal output to the second switches based on a value of the selected second data variable.

2. The converter controller of claim 1, wherein the second core is further configured to store the PWM control values for the second switches in one of two second data variables,
wherein the two second data variables are alternately selected and used.

3. The converter controller of claim 1, wherein the second core is further configured to store, in an index variable, a sequence number selected for a current control period or a sequence number to be selected for the next control period, among the plurality of second data variables.

4. The converter controller of claim 3, wherein the first core is further configured to check the second data variable selected according to the sequence number by the index variable.

5. The converter controller of claim 1, wherein the plurality of second data variables is configured as an array, and one of the second data variables in the array is selected according to the sequence number.

6. The converter controller of claim 1, wherein the first core is further configured to store the PWM control values for the first switches in one of a plurality of first data variables selected according to a sequence number.

7. The converter controller of claim 6, wherein the plurality of first data variables and the plurality of second data variables are located in a buffer shared by the first core and the second core.

8. The converter controller of claim 6, wherein the first core is further configured to:
configure the registers for PWM signal output to the first switches based on the value of the selected first data variable; and
configure the registers for PWM signal output to the second switches based on the value of the selected second data variable.

9. The converter controller of claim 8, wherein, in a top-level Interrupt Service Routine (ISR), the first core is further configured to:
configure the registers for PWM signal output to the first switches; and
configure the registers for PWM signal output to the second switches.

10. The converter controller of claim 9, wherein the top-level ISR is invoked a certain amount of time before a start of a new control period and is finished before the start of the new control period.

11. The converter controller of claim 1, wherein the PWM control values include at least one of a value indicating a duty cycle of the PWM signal or a value indicating a period of the PWM signal.

12. The converter controller of claim 1, wherein the first core is further configured to:
generate a rising edge time value or falling edge time value of the PWM signal from the value of the selected second data variable; and
store the rising edge time value or falling edge time value in the registers for PWM signal output to the second switches.

13. The converter controller of claim 1, further comprising timer output modules (TOMs) configured to output a PWM signal to the first switches and the second switches,
wherein the first core is further configured to configure shadow registers (SR) respectively corresponding to the TOMs.

14. The converter controller of claim 13, wherein each TOM includes a first CM register used for setting a rising edge of the PWM signal and a second CM register used for setting a falling edge of the PWM signal,
wherein values stored in the shadow registers are transmitted to the first CM register and the second CM register at a start of a control period.

15. The converter controller of claim 1,
wherein the first core is further configured to:
perform, in each control period, a process of acquiring sensing values from an Analog-to-Digital Converter (ADC) for the first PFC circuit, a voltage control process, and a current control process; and
calculate the PWM control values for the first switches, and
wherein the second core is further configured to:
perform, in each control period, a process of acquiring sensing values from an ADC for the second PFC circuit, a voltage control process, and a current control process; and
calculate the PWM control values for the second switches.

16. A converter control method comprising:
calculating, by a first core, pulse width modulation (PWM) control values for first switches included in a first power factor correction (PFC) circuit;
calculating, by a second core, PWM control values for second switches included in a second PFC circuit;
storing, by the first core, the PWM control values for the first switches in one of a plurality of first data variables selected according to a sequence number;
storing, by the second core, the PWM control values for the second switches in one of a plurality of second data variables selected according to a sequence number; and
configuring, by the first core, registers for PWM signal output to the first switches based on a value of the selected first data variable and registers for PWM signal output to the second switches based on the value of the selected second data variable.

17. The converter control method of claim 16, wherein, storing the PWM control values for the first switches comprises storing, by the first core, the PWM control values for the first switches in one of two first data variables, and the two first data variables are alternately selected and used,
wherein, storing the PWM control values for the second switches comprises storing, by the second core, the PWM control values for the second switches in one of two second data variables, and the two second data variables are alternately selected and used.

18. The converter control method of claim 16, further comprising:
storing, by the first core and the second core, in an index variable, a sequence number selected for a current control period or a sequence number to be selected for the next control period.

19. The converter control method of claim 16, wherein configuring registers for PWM signal output to the first switches and the second switches is performed in a top-level Interrupt Service Routine (ISR) of the first core.

20. The converter control method of claim 19, wherein the top-level ISR is invoked a certain amount of time before a start of a new control period and is finished before the start of the new control period.
